(19) United States
(12) Patent Application Publication
(10) Pub. No.: US 2013/0054886 A1
(43) Pub. Date: Feb. 28, 2013

(54) CONTENT ADDRESSABLE MEMORY (CAM)

(71) Applicants: Kamran Eshraghian, Rostrevor (AU); Kyoungrok Cho, Taejon City (KR); Peter Graham Foster, Parkside (AU)

(72) Inventors: Kamran Eshraghian, Rostrevor (AU); Kyoungrok Cho, Taejon City (KR); Peter Graham Foster, Parkside (AU)

(73) Assignee: IDATAMAP PTY. LTD., Leeming, Western Australia (AU)

(21) Appl. No.: 13/575,177

(22) PCT Filed: Jan. 25, 2011
(86) PCT No.: PCT/AU2011/000077

§ 371 Date: Nov. 14, 2012

(30) Foreign Application Priority Data
Jan. 25, 2010 (AU) 2010900271

(51) Int. Cl. G06F 12/00

(52) U.S. Cl. 711/108; 711/E12.001

(57) ABSTRACT

A non-volatile Content Addressable Memory element including a non volatile memristor memory element; a data bus for applying a data signal to be programmed into the memristor memory element; a search bus for applying a search term; an output or match bus; logic to selectively enable the search bus and the data bus; wherein the logic is configurable to set the logic state of the memristor according to a logic signal applied to the data bus, and configurable to enable the logic state of the memristor to be compared to a logic state on the search bus with the match bus signaling a true logic state upon matching.

### FIELD OF INVENTION

Content Addressable Memory (CAM) compares input search data against a table of stored data, and returns the address of the matching data. The main drawback of present CAM designs is the power consumption associated with the large amount of parallel active circuitry and loss of data if the power source is disabled, unless very complex power consuming dynamic techniques are used to restore data once power is restored. As memory density increases so does the power requirement of CAM and hence design of CAMs bring new challenges in relation to power consumption and data retention in absence of a power source. Furthermore emerging limits of processing technology placed upon scaling of Metal Oxide Semiconductor (MOS) devices beyond 10 nm necessitates the realization of alternative circuit elements having reduced area and power consumption demanded by larger Content Addressable Memory (CAM) subsystems and systems.

### BACKGROUND

A Content Addressable Memory (CAM) is a memory that implements the lookuptable function in a single clock cycle using dedicated comparison circuitry. The overall function of a CAM is to take a search word and return the matching memory location. Many versions of the basic CAM cell using a variety of MOS and Complementary Metal Oxide Semiconductor (CMOS) technology have emerged over the years with the main objective of increasing the data storage capacity, increasing the speed of search and compare operations and to reduce power consumption. A typical content addressable memory (CAM) cell forms a Static Random Access memory (SRAM) cell that has two n-type and two larger p-type MOS transistors, which requires both V_{DD} and GND connections as well as well-plugs within each cell.

The SRAM within CAM consumes silicon area, dissipates power and cannot retain data once power source is disabled and then reinstated as part of power saving management for large CAM arrays. Resistive Random Access Memory (RRAM) was also explored but it is susceptible to high defect rates, a high degree of variability, and has problems to scaling of nanodevices.

A brief overview of a conventional CAM cell using static random access memory (SRAM) is shown in FIG. 26(a). The two inverters that form the latch use four transistors including two p-type transistors that normally require more silicon area. Problems such as relatively high leakage current particularly for nanoscaled CMOS technology and the need for inclusion of both V_{DD} and ground lines in each cell bring further challenges for CAM designers in order to increase the packing density and still maintain sensible power dissipation.

Fundamentally, a main technique used to design an ultra low-power memory is voltage scaling that brings CMOS operation down to the sub-threshold regime. It has been demonstrated that at very low supply voltages the Static Noise Margin (SNM) for SRAM will disappear due to process variation. To address the low SNM for sub-threshold supply voltage SRAM cell shown in FIG. 26(b) was proposed. This means, however, that there is a need for significant increase in silicon area to have reduced failure when the supply voltage has been scaled down.

Failure is a major issue in designing ultra dense (high capacity) memories. Therefore, a range of fault tolerance techniques are usually applied. As long as the defect or failure results from the SRAM structure, a traditional approach such as replication of memory cells can be implemented. Obviously it causes a large overhead in silicon area which, exacerbates the issue of power consumption.

### BRIEF DESCRIPTION OF THE DRAWINGS

The present invention will be discussed hereinafter in detail in terms of the preferred embodiment of a Content-Addressable Memory (CAM) according to the present invention with reference to the accompanying drawings. In the following description, numerous specific details are set forth in order to provide a thorough understanding of the present invention. It will be obvious, however, to those skilled in the art that the present invention may be practiced without these specific details.

FIG. 1. Content Addressable Memory Generic Architecture.

FIG. 2. Example of Generic approach already developed in identifying a search data that corresponds to identification of a Port, in this case being Port B.

FIG. 3. Present CAM architecture broken into sub-blocks so that power from selected sections can be removed to conserve power. Note also that when power is resorted, data also has to be restored in the respective block.

FIG. 4. Physical structure of a Memristor using Platinum (Pt) nanowires and TiO₂/TiO₂₋ₓ, where Titanium Dioxide maybe replaced by other suitable nanomaterial.

FIG. 5. Implementation of Memristor overlaid on a Silicon CMOS substrate. Note the importance of compatibility with standard CMOS process technology.

FIG. 6. NOR type Memristor-MOS CAM (MCAM) element with separate Data (D) and Search (S) busses.

FIG. 7. Basic Circuit for combination of Memristor and Transistor as non volatile memory element.

FIG. 8. Table illustrating state of Memristors and the state of Match Line ML.

FIG. 9. Illustration of the signal levels used to write Data corresponding to logic “1” onto the MCAM element of FIG. 7.

FIG. 10. Illustration of the signal levels used to write Data corresponding to logic ‘0’ onto the MCAM element of FIG. 7.

FIG. 11. NOR-type Memristor-MOS CAM (MCAM) with Merged Data and Search Buses (D/S).

FIG. 12. Illustration of the signal levels used to Read data from the NOR-type Memristor-MOS CAM element of FIG. 11 with Merged Data and Search Buses (D/S).

FIG. 13. Illustration of the signal levels used to Write data to the NOR-type Memristor-MOS CAM element of FIG. 11 with Merged Data and Search Buses (D/S).

FIG. 14. Variation of the Memristor-MOS CAM with separate Data (D) and Search (S) buses.

FIG. 15. NAND-type Memristor-MOS CAM with separate Data (D) and Search (S) buses.

FIG. 16. Block diagram for Memory/Compare section of Memristor CAM.

FIG. 17. Architecture for Memristor CAM MCAM broken into sub-blocks that would allow removal of power from selected blocks without loss of data.

FIG. 18. Generic Architecture for Encryption/Decryption processor.

FIG. 19. Addressing and selection of a group of MCAMs.

FIG. 20. NAND-type Memristor-MOS CAM with merged Data (D) and Search (S) bus.

FIG. 21. Implementation of 21 by 2 element MCAM showing output when a match occurred.

FIG. 22. Waveform for 21×2 MCAM.

FIG. 23. Cross-coupled MCAM which speeds frequency of operation necessary for long data.

FIG. 24. Architecture for 21×2 MCAM using Cross-coupled MCAM with inverted data.

FIG. 25. Waveform for 21×2 Cross-coupled MCAM illustrating inverted signals on the output of Match Line.

FIG. 26. Conventional CAM cell using SRAM.

FIG. 27. Memristor Ternary Content Adressable Memory (MTCAM) cell structure with self-reset transistors.

FIG. 28. MTCAM Encoding Table.

FIG. 29. Write operation timing diagram; (a) input signal, (b) program state x(t).

FIG. 30. Match operation timing diagram.

### SUMMARY OF THE INVENTION

This invention concerns the creation of Memristor Content-Addressable Memory (MCAM)

Content Addressable memory (CAM) compares input SEARCH DATA against a table of STORED DATA, and returns the ADDRESS of the matching data.

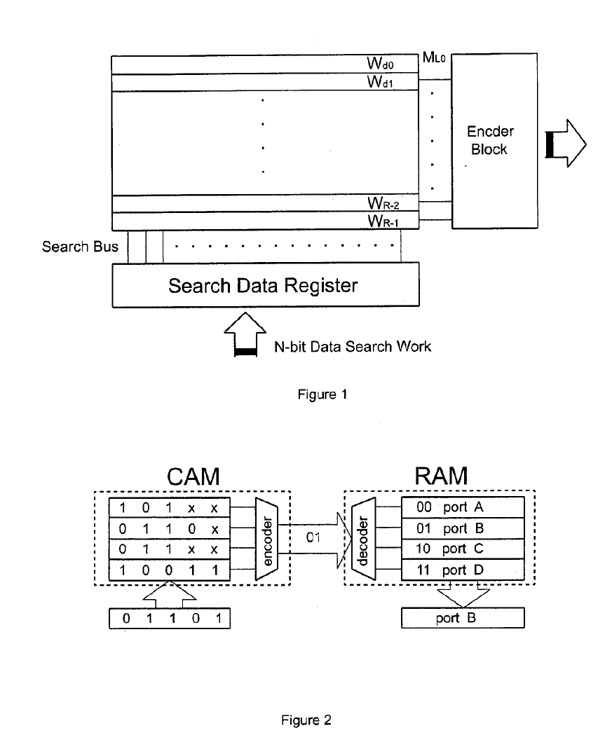

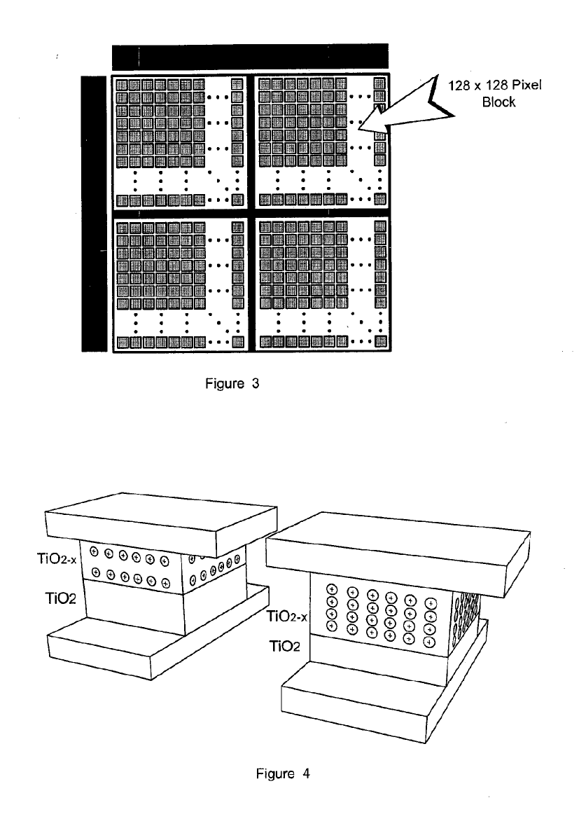

Content Addressable Memory (CAM) is a memory that implements the lookup table function in a single clock cycle using dedicated comparison circuitry. The idea of CAM that has emerged over years is shown in a block form in FIG. 1, FIG. 2 and FIG. 3.

FIG. 2 highlights the generic concept of CAM. The CAM component of FIG. 2 corresponds to the CAM block of FIG. 1, where the search term is a 5-bit number and there are four registers corresponding to W of FIG. 1. The search term, in this case the binary number “01101”, is latched into the search bus and compared to each of the four registers, labeled “0” through “3”. Register 1 contains a match to the search term resulting in an encoder output of “01” (the binary representation of register “1”). The encoded address is passed to a RAM which contains the output parameters. The encoded binary value “01” is decoded in the RAM and this points to memory address decimal “1”. The data contained in memory address decimal “1” is “Port B” which appears on the output. If this were a four port router and the address of the TCP/IP header packet was “01101” then the router would send the data contained in said packet to port B.

FIG. 3 illustrates an example of implementation of groups of cells within blocks.

CAMs are especially used in network routers for packet forwarding and packet classification. In networks like the Internet, a message such an as a Web page or e-mail is transferred by first breaking up the message into small data packets of a few hundred bytes, and, then, sending each data packet individually through the network. These packets are routed from the source, through the intermediate nodes of the network referred to as routers, and then are reassembled at the destination to reproduce the original message.

The function of a router is to compare the destination address of a packet to all possible routes, in order to choose the appropriate one. Therefore a CAM is used for implementing this lookup operation due to its search capability that can occur in one clock cycle. The primary commercial use of CAMs is to classify and forward Internet protocol (IP) packets in network routers.

Usually the input to the system is the search word being broadcast onto the SEARCH LINES or SEARCH BUS to the table of stored data. The number of bits in a CAM word is usually large, for example with existing implementations ranging from 36 to 144 bits or more. It is likely that bits in a CAM can expand to 256 and possibly 512 bits. A typical CAM employs a table size ranging between a few hundred entries to 32000 entries, corresponding to an address space ranging from 7 bits to 21 bits. This table size will increase significantly with demand on an increase in size and speed of search engines.

CAMs can be used in a wide variety of applications that require a search and want a return of results in one clock cycle. Furthermore CAMs are also used in applications where high-speed table lookup is the key element in the system architecture. These applications include image coding, parametric curve extraction, Hough transformation, Huffman coding/decoding, Lempel-Ziv compression, and many others.

There are many variations of implementing CAMs. However the main drawback of present CAM designs are that if power is removed usually data is lost, unless some form of dynamic structures are used to refresh the data, or an auxiliary power source is provided such as a back up battery. These additions can be power hungry and the power consumption associated with the large amount of parallel active circuitry is usually high. As memory density increases so does the power requirement of CAM circuits and hence design of CAMs bring new challenges in relation to power consumption.

Replacement of SRAM in the classic CAM with alternative circuit structure that provides enhanced properties including reduced area, ability for data retention when power source is removed and reduced power dissipation that overcome limitations of SRAM based CAMs permits realization of much larger CAMs that allow for enhanced and superior performance.

The design of the MEMRISTOR CONTENT ADDRESSABLE Memory (MCAM) cell is based on the circuit element, Memristor (M) predicted by Chua in 1971. Chua postulated that a new circuit element defined by the single-valued relationship dφ=Mdq must exist whereby current moving through Memristor (M) would be proportional to the flux φ of the magnetic field that had flowed through the material.

The magnetic flux φ between the terminals is a function of the amount of charge q that has passed through the device. This follows from Lenz's law whereby dφ=Mdq has the equivalence v=M(q)i. The Memristor is characterized by an equivalent time-dependent resistor whose value at a time t is linearly proportional to the quantity of charge q that has passed through it.

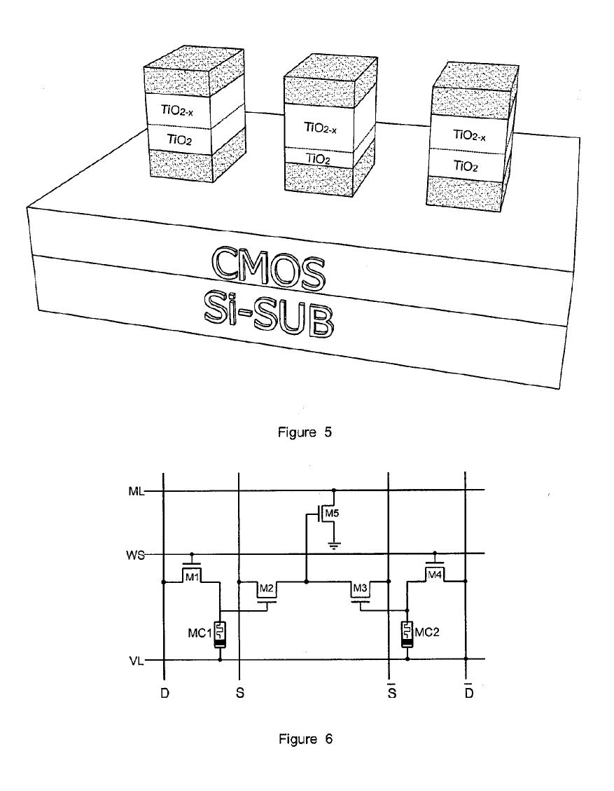

The Memristor behaves as a switch, comparable in some respects to a MOS transistor. However, unlike the transistor, the Memristor is a two-terminal device (see FIG. 4) rather than a three-terminal device and does not require power to retain its data state. The significant difference between the two devices is that a transistor stores data by electronic charge while the Memristor stores data through resistance state. Only ionic charge can change the resistance of Memristor and such resistance change is non-volatile. This behaviour is an important property for the Memristor Content Addressable Memory (MCAM) based system where the power from sections of MCAM can be disabled without the loss of stored data allowing significant saving in power dissipation.

To help with understanding of the Memristor a brief functioning of the device is provided. William et al. of HP presented a physical model whereby the Memristor (M) is characterized by an equivalent time-dependent resistor whose value at a time t is linearly proportional to the quantity of charge q that has passed through it.

The Memristor consists of a thin nano layer (2 nm) of TiO₂ and a second Oxygen deficient nano layer of TiO₂₋ₓ (8 nm) sandwiched between two Platinum (Pt) nanowires (50 nm) as shown in FIG. 4.

Oxygen (O²⁻) vacancies are +2 mobile carriers and are positively charged. A change in distribution of O²⁻ within the TiO₂ nano layer changes the resistance. By applying a positive voltage to the top Platinum nanowire oxygen vacancies drift from the TiO₂₋ₓ layer to the TiO₂ undoped layer, thus changing the boundary between TiO₂₋ₓ and TiO₂ layers. As a consequence the overall resistance of the layer is reduced which corresponds to an “ON” state, or in Binary Notation corresponds to logic “1” state.

When enough charge passes through the Memristor that ions can no longer move, the device enters a hysteresis region and keeps q at an upper bound with fixed Memristor resistance (M).

By reversing the process, the oxygen defects diffuse back into the TiO₂₋ₓ nano layer. Resistance returns to its original state which corresponds to an “OFF” state or in Binary Notation corresponds to logic “0”. The significant aspect is only ionic charges, namely the oxygen vacancies (O²⁻) through the cell, change the Memristor (M) resistance.

FIG. 4 shows the physical structure of a single Memristor as part of a cross-bar architecture. This structure is replicated in a two-dimensional array of memristor elements within the memory. Applying a voltage of appropriate polarity between the Upper Platinum nanowire and the lower Platinum crossbar nanowire pair allows a particular location in the memory to be selected to either WRITE DATA or READ Data. For example when a crossbar junction is selected by applying a voltage to the crossbar's top layer, oxygen vacancies drift into lower undoped TiO2 layer, changing the resistance.

A Memristor Content Addressable Memory (MCAM) serves three basic functions:

a) tores DATA and retains DATA without the need for a power source;

b) Memory can be partitioned into blocks allowing the power source to be removed from blocks or group of blocks as part of power saving management without loss of data; and

c) Enables comparison between SEARCH BIT and STORED DATA BIT once power is reapplied to a selected group or groups of blocks without the need for restoration of DATA.

An important aspect of the MCAM disclosed here is that it is compatible with existing CMOS technology. This means that the MCAM can be manufactured on a standard CMOS/Silicon wafer as shown in FIG. 5.

There are number of approaches in the design of a basic MACM element or cell such as NOR-based match line, NAND-based match line, etc.

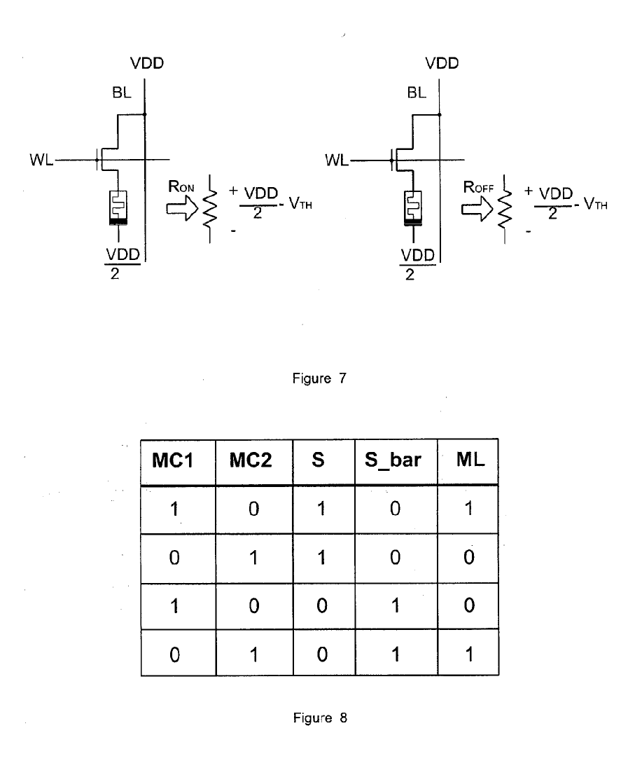

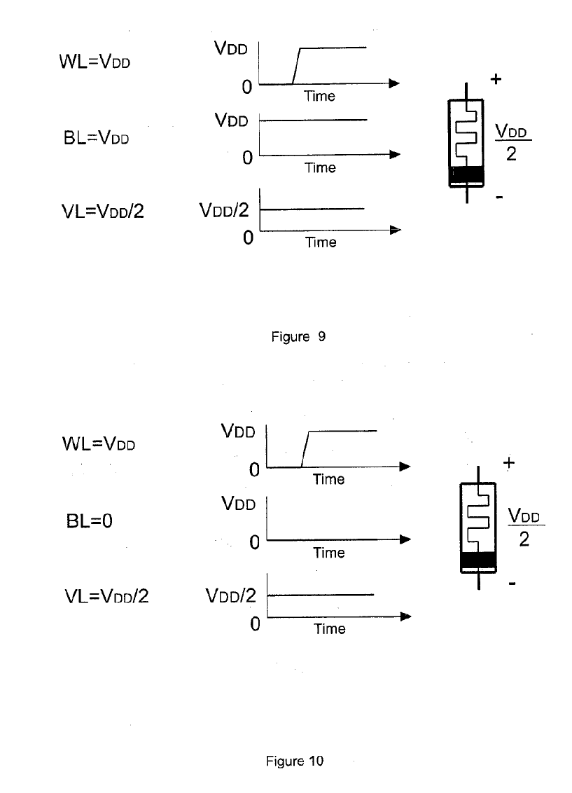

The basic NOR-based MCAM cell is shown in FIG. 6. In this architecture a separate Data Bus and Search Bus are implemented. The WRITE part of the circuit (FIG. 6) is illustrated by FIG. 7 with the waveforms used to write data to the cell shown by reference to the corresponding waveforms of FIG. 9 and FIG. 10.

The waveform in FIG. 9 shows the circuit parameters required to write a low resistance or logical “1” state to the Memristor cell. If the data to be stored is a logical “1” or “high”, the Memristor receives a positive bias that charges the Memristor and results in an “ON” state or logical “1”. To write a high resistance to the Memristor cell, FIG. 10 shows that a reverse bias is applied to the Memristor cell, programming it to logic “0” or “low”.

With reference to the MCAM cell of FIG. 6, a complete cycle of operation is as follows:

During WRITE CYCLE, DATA and its complement DATA_bar are placed on DATA BUS D and DATA BUS D_bar. A positive voltage equivalent to VDD/2 is applied to MEMRISTOR BIAS LINE VL. WORD SELECT LINE WS is asserted. The WRITING operation onto MC1 then follows the waveforms of FIG. 9 for Logic “1” state while its complement, a Logic “0” is written onto MC2 by the waveforms of FIG. 10.

During the SEARCH cycle, SEARCH DATA is applied to SEARCH BUS S and its complement is applied to S_bar BUS. A very short pulse of duration of about several nanoseconds (typically 5 ns to 10 ns) is applied to MEMRISTOR BIAS LINE VL which samples the states of MEMRISTORS MC1 and MC2 and activates MATCH LINE ML which can be configured in a number of ways to detect a match state through transistor M5. FIG. 8 represents the logic table associated with a search of the single MCAM cell of FIG. 6.

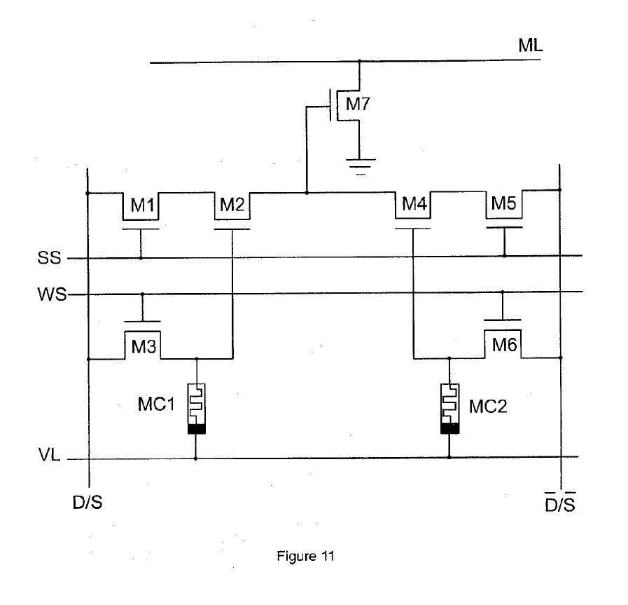

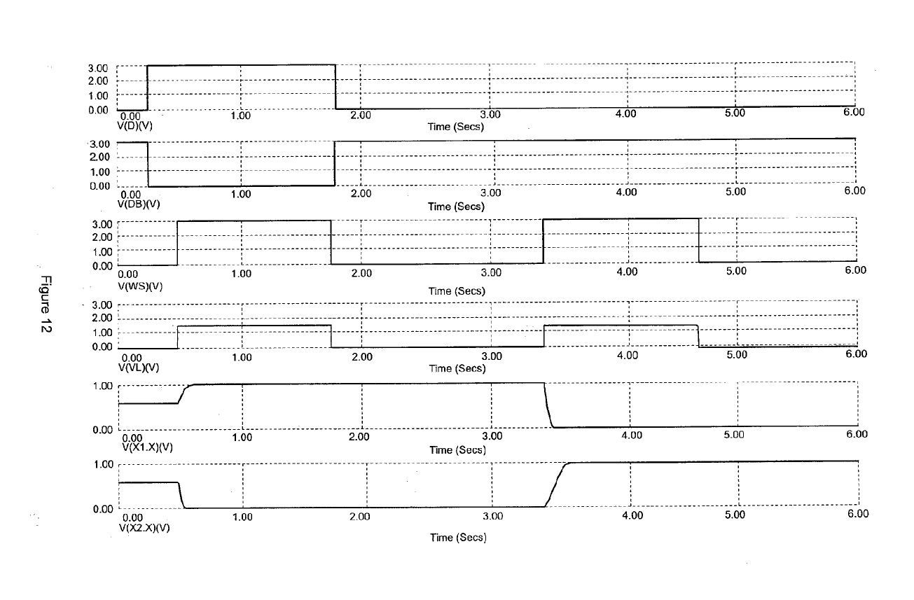

It is possible to merge Data Bus and Search Bus also. This method of merging Data Bus and Search Bus in the MCAM is shown in FIG. 11 by inclusion of SEARCH SELECT LINE SS and SEARCH ACCESS transistors M1 and M5. When SS line is asserted the cycle of operation is as before. The entire cycle of a WRITE operation is shown by the related waveforms of FIG. 12.

When specific data is written onto the memory, it is placed on the data bus “D” and it complement onto data bus “D_bar”. In this case the WORD SELECT LINE WS is asserted while the SEARCH SELECT LINE is not activated. Memristor BIAS LINE is activated. During this entire cycle said specific data that is on data bus “D” is written onto Memristor MC1 while the complement of said specific data, on data bUS D_bar is written onto Memristor MC2.

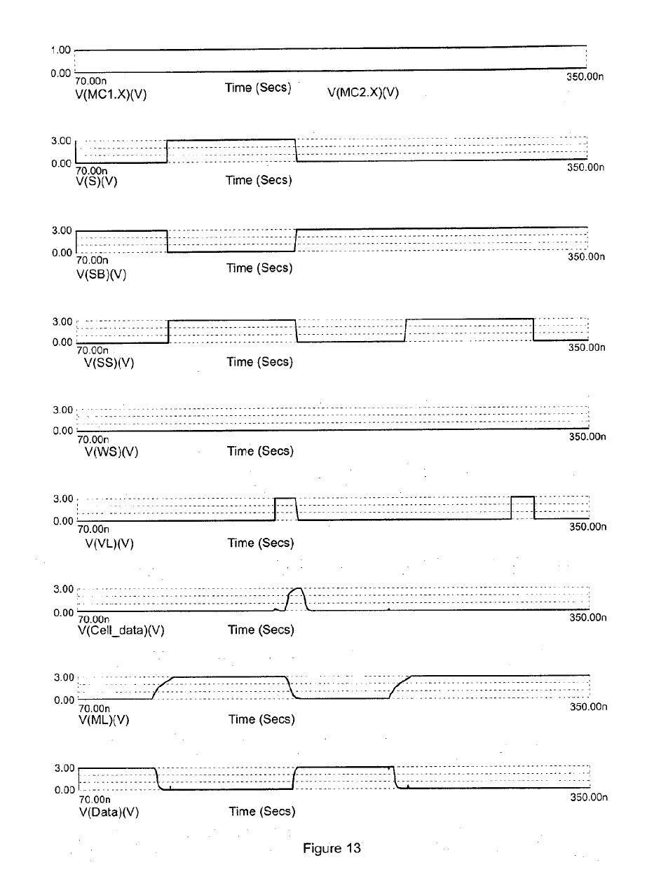

The WRITE cycle is completed by deactivating WORD SELECT WS line. Waveforms illustrating SEARCH and MATCH operation is shown in FIG. 13. During this cycle of operation the SEARCH DATA is placed upon SEARCH BUS “SS” and its complement is placed on the SEARCH_bar BUS. The SEARCH SELECT LINE is asserted.

A short pulse of duration in the order of a few nanoseconds is provided by BIAS LINE VL. Data on SEARCH BUS S and its complement on SEARCH BUS S_bar are compared with the state of the Memristors MC1 and MC2. If the data on SEARCH bus is the same as the Logic state of the MERISTOR MC1 and the data on SEARCH_bar is the same as the Logic state of the MERISTOR MC2, then MATCH LINE ML is activated otherwise MATCH LINE ML remains deactivated.

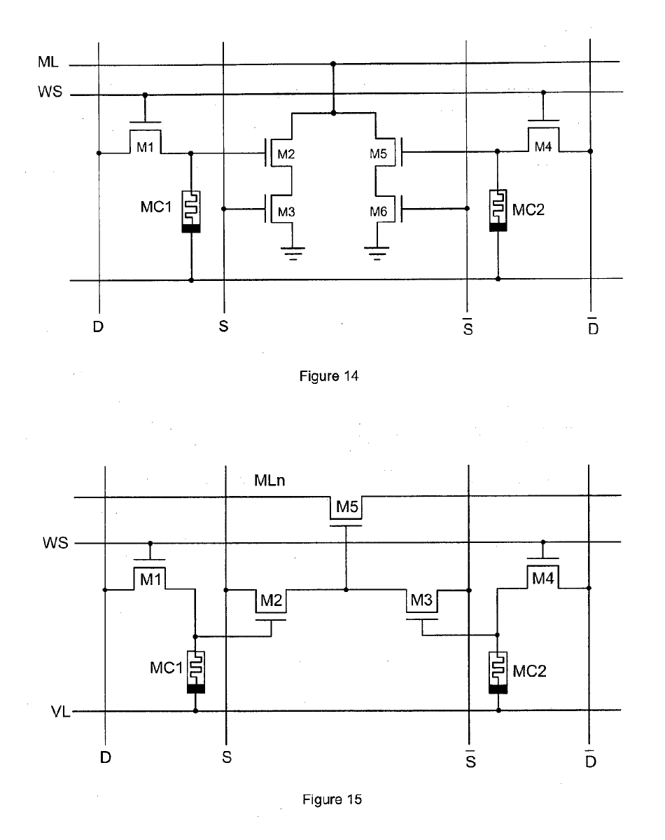

There are variations of the Memristor based CAM circuits that use the approach presented. FIG. 14 shows such an alternative cell with NOR-based MATCH LINE whereby transistors M3 and M6 are Enable transistors to allow transistors M2 and M5 to sample the state of Memristor MC1 during the search cycle when a short WRITE signal (in the order of Nanoseconds is applied to MEMRISTOR BIAS LINE VL. This cell also can be easily modified to merge the DATA BUS and SEARCH BUS.

FIG. 15 illustrates variation of MCAM cell using NAND-based MATCH LINE as a means for comparison.

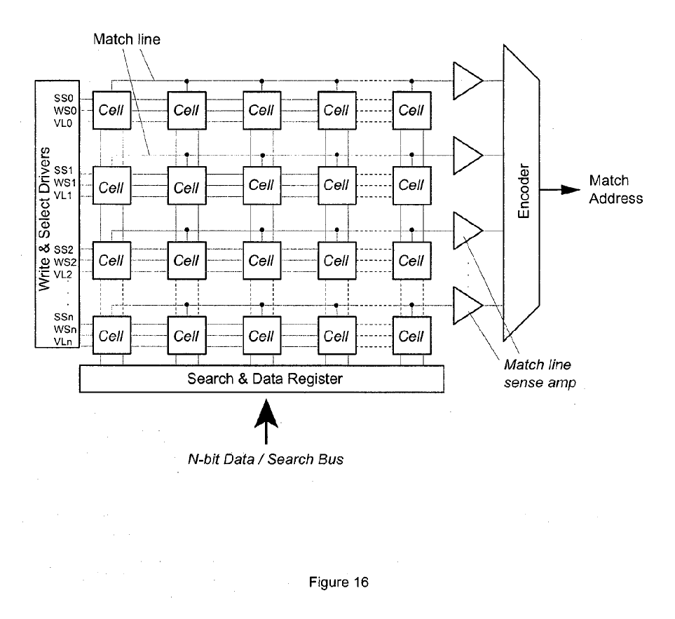

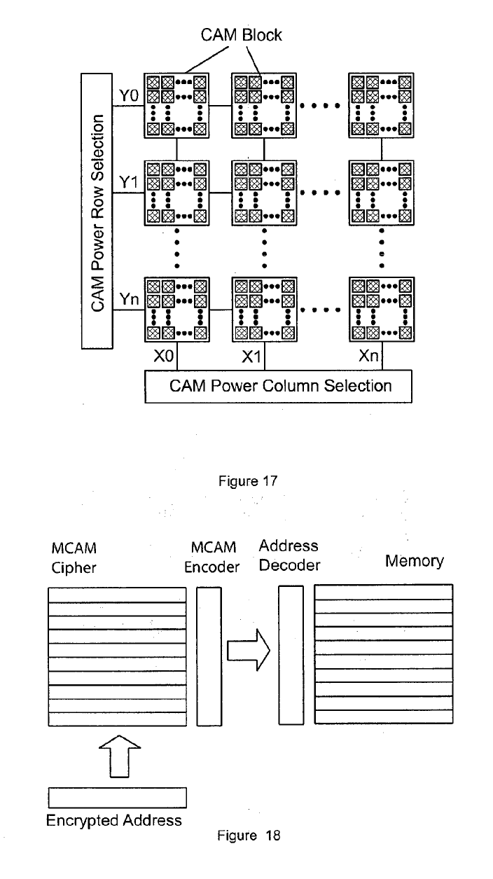

FIG. 16 illustrates configuration of an MCAM block using integrated Data and Search Bus. FIG. 17 shows the significant aspect of the invention where search can be targeted to a sector or group of blocks. In this case power is applied to the selected MCAM block while power is removed from other MCAM blocks or group of MCAM blocks. When SEARCH requires other grouping of blocks, power is only applied to these groups again and the cycle of operation for WRITE and MATCH is as described before. There is no need for refreshing of memory storage and hence significant saving in power consumption.

In one broad aspect the Memristor Content Addressable Memory (MCAM) of the present invention provides a means (method and apparatus) of reducing the power consumption of a Content Addressable Memory (CAM) while maintaining a high search speeds. In the first instance the non-volatile nature of the MCAM means that it does not need to be continually refreshed, as is the case with SRAM based Content Addressable Memories. Furthermore, the MCAM of the present invention provides a means of reducing the overall power consumption of the CAM by allowing selective powering of a subset of CAM blocks without reducing the speed of the CAM. Most notably, the present invention provides a means of rapidly reconfiguring a CAM while saving power and obviating the need to refresh memory or reload memory after a power down sequence.

In this case, the MCAM can be implemented as a simple device with either separate or integrated Data and Search busses.

Of particular interest is the power saving ability of an MCAM. Sections of the MCAM can be searched while other areas may remain in a powered-down state. This will save significant amounts of power thereby reducing thermal issues in large MCAMs and has the potential to generate significant cost savings. Reduced thermal loading allows increased miniaturisation and device density on a wafer thereby reducing the materials-based cost per MCAM cell. Operational cost savings come from reduced thermal management requirements and a simple reduction in electrical power costs.

In the case where a large scale CAM is implemented, the present invention provides reconfiguration of CAM blocks (selectively powering only required CAM blocks) on short timescales not possible with other forms of volatile memory due to their need to reload data for a given CAM block on powering it back up. Furthermore the Memristor element and associated read/write circuitry disclosed in the present invention operates at speeds comparable with volatile memory based Content Addressable Memories.

In the case of a network router the present invention reduces the power consumption and operating costs. The header of a TCP/IP packet that is passing through the internet contains the address of the destination node or computer. This header is decoded by the router and the appropriate port chosen for delivering the packet on toward its destination. The present invention would enable a router to operate at significantly reduced power consumption over existing technologies that require continual refreshing of SRAM. It offers a permanent memory after power has been removed and is several orders of magnitude faster than comparable FLASH-memory based permanent memories.

In another broad aspect, the present invention provides a method for improving data security. An MCAM is used as a hardware cipher. Such a cipher acts as a non-volatile address crypt for an associated memory device. The Cipher can be updated with a new key at any time; it provides a low power decryption mechanism and operates several orders of magnitude faster than comparable Flash memory based architectures.

This may be explained with reference to FIG. 18. A particular decryption key is loaded into the non-volatile MCAM Cipher chip. When someone tries to access the protected memory chip with an unencrypted address, the MCAM is unable to point to the correct memory location and the resulting data fetch returns useless data. Only a memory address that is correctly encrypted will be deciphered properly by the MCAM Cipher. Furthermore multiple cipher keys may be encrypted within a given MCAM at the same time. A plurality of MCAM blocks may be configured to each contain a separate key. It will be readily appreciated by those skilled in the art that a Memristor memory may also be used as said associated memory device with said MCAM cipher.

In another broad aspect the MCAM of the present invention provides a highly scalable hardware-based architecture for the analysis of data. In a first preferred embodiment the present invention is provides a scalable hardware-based architecture for the search engine industry. Search engines such as Google, Bing, AltaVista, Yahoo etc. use software applications known as robots to “crawl” the internet for content. These web pages retrieve content and links between web pages ultimately creating a searchable index of the content they find.

Search engine architectures vary in the way indexing is performed and in methods of index storage to meet the various design factors. Common types of indices include the Forward index, the Inverted index, the Citation index, the Ngram index and the Document-term matrix each with their specific advantages and limitations. Moreover a given search engine architecture may require the creation of several of these indices. As a result of the enormous amount of data involved, data is often compressed or filtered in order to reduce the computer storage requirements.

Search engines employ vast data centres with massive arrays of memory and indexes. These facilities consume enormous amounts of power. Memristor technology offers the potential for very large scale memories operating several orders of magnitude faster than current flash memory devices. Furthermore, terabit memories and larger based on memristors are now practical. An MCAM device therefore offers the potential to create search engine indexes in memory rather than being stored on physical drives. The speed, packing density, permanent nature of the memory and its low power consumption make MCAMs ideal for this application.

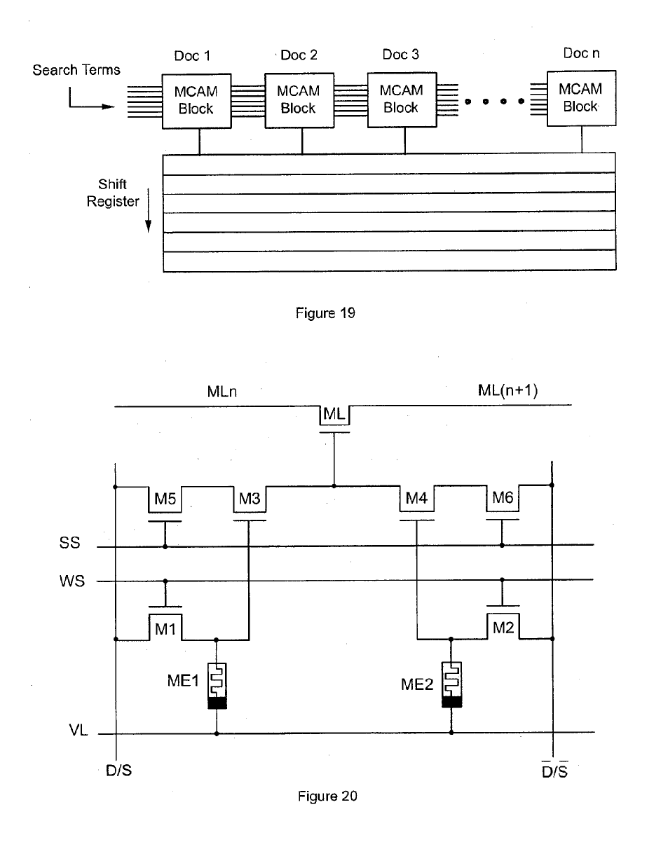

In one embodiment an array of MCAM blocks is configured to map the contents of a given document or web page (in the case of an internet search engine) to a single MCAM block. This is otherwise known as a Forward Index. This is a list of all the words to be found within a given document. Although this form of search MCAM may contain a large sparse data set, the power savings and miniaturization possible with a MCAM provide significant benefits. A plurality of search terms are pipelined into the MCAM network—with the same term applied to all MCAM blocks simultaneously. If a given search term is found within an MCAM block, it's output register is latched with a binary logical ‘true’ result, otherwise a logical ‘false’ is latched. As successive search terms are pipelined into the MCAM ‘search’ register (or onto the Search Bus) the plurality of output registers are latched into a shift register. After all of the search terms have been applied to the MCAM array, the shift register (which may be implemented in either hardware or software—or a combination) provides a list of (or pointer to) all of the documents that contain each of the search terms in what is commonly referred to as an Inverse Index. This may be more clearly described by way of FIG. 19. According to this method, and depending on the type of index chosen for the search architecture, each MCAM block can be configured with the data from a single document or web page. A sequence of search terms are sequentially fed into the search term register and clocked through the system. On each clock cycle, a search term is compared to the MCAM block (or document) and if a match is found in that block, a logical “true” is latched onto the output to the single bit “match register”. This can be accomplished by using a logical OR on the match line for each element of the MCAM block. This process is done in parallel with many MCAM blocks and all of the single bit output match registers are concatenated into a single output word. This word will be as long (number of bits) as the number of discrete documents in the database (or may be smaller with multiple words output), where each bit of the word corresponds to a given document.

As each search term is pipelined into the MCAM, the output word is pipelined into a shift register. The shift register then contains a map of all the documents that contain the plurality of search terms. It is a simple process then to find the number of search terms found within a given document by adding each bit of the shift register with the corresponding bit for each search term applied to the MCAM.

The important point to note with the MCAM architecture disclosed in this invention is that the MCAM can remain in a powered-down state until a search request comes in. As soon as power is applied to the MCAM, it is available for search, without needing to refresh the CAM data. Furthermore, it is possible to apply power to only sections of the MCAM that are relevant to a given search. In this preferred embodiment, each MCAM block is powered in rows. Once power has been applied to a given MCAM block, a search term mask is used to determine the number of bits in the search term. Power is then only applied to those rows of the MCAM that correspond to a possible search term match, further reducing the power consumption.

Furthermore, as data is updated (for example by bots crawling the web) individual MCAM blocks may be updated or completely rewritten. The process of writing to the memory is very power efficient as power needs only to be applied to the specific MCAM element.

In yet another preferred embodiment, the present invention provides a method of for searching for large data patterns in a file or data stream—data mining. An equivalent apparatus and system for this search method is also provided. One particular application for this might be in searching a genome for a specific gene or pattern of base pairs. The human genome contains about 23,000 protein-coding genes and 3.3×10⁹ base pairs.

A specific case of this is a method of detection for virus programs passing through a network. This could be any network, but is described by way of example as an Ethernet network. Data is received at a first port, which may be a port of an Ethernet router, and as it passes through the router is scanned for the digital signatures of known viruses.

The data passes through a shift register before passing to a second port of said Ethernet router for downstream transmission. The contents of the shift register is compared to the known digital virus signatures stored in the CAM on every clock cycle, or every shift process, of the shift register. When a match is detected, data may either be transmitted on the second port of the Ethernet router or may be quarantined and the downstream stopped to prevent spread of the virus.

It is important to note that in the case of a TCP/IP transmission, there are packet headers which would need to be stripped off before comparison of the data payload by passing only the payload through the shift register.

Furthermore the router of this example may contain an onboard ring buffer, large enough to store the entire contents of many TCP/IP packets. The ring buffer would preferably be long enough to store far more than the longest virus signature known. The data stream (which would include TCP/IP headers in this case) would be shifted out of the shift register and into the ring buffer. Only virus free ring buffer contents would then be transmitted downstream at the second port.

The ring buffer therefore provides a delay mechanism between reception of data at the first port and transmission at the second port. This delay should be long enough to detect the entire digital signature of a virus and then allow cancellation of the downstream transmission process to stop spread of the virus.

This apparatus may be implemented in a TCP/IP network router to stop such files spreading across a local network, in a telecommunication company's large scale routers in the core of the network or even within the Media Access Controller (MAC) of an Ethernet port on a personal computer for a final line of protection.

The pattern detection system may be optimized to reduce power consumption by powering down parts of the MCAM when not needed. For example, the MCAM must be fully powered while looking for an initial match to a very long data pattern, but then only needs to be powered for every ‘n^{th}’ subsequent clock cycle of the shift register after the initial match, where ‘n’ is the bit width of the shift register. Once the data pattern has been detected in its entirety, the MCAM needs to be fully powered again in search of the next pattern. There is another possibility. It is possible that there is an initial match but subsequent matches do not confirm the presence of the entire pattern. In this case, as soon as the pattern fails to match, the MCAM is fully powered. If the location of the beginning of the pattern within the data record is required, then a counter may be used to count the number of shift register cycles before the initial match is obtained.

Power efficiency of the MCAM pattern detection system may be further optimized by initially only powering a small segment of the MCAM. This is equivalent to only searching on the first portion of the shift register. For example consider a 1024-bit wide shift register. It may be decided that the first 32-bits of the pattern are required to make a reasonable guess that the pattern has started. In this case, you would apply power only to the first 32-bit wide rows of the MCAM and search the first 32-bits of the shift register on every clock cycle. If a match is detected, then the whole MCAM would be powered to check if the full 1024-bit wide pattern is still matched. The MCAM could then be powered down for the next 1024 shift register clock cycles and powered up again on every 1024th cycle to continue matching the entire pattern.

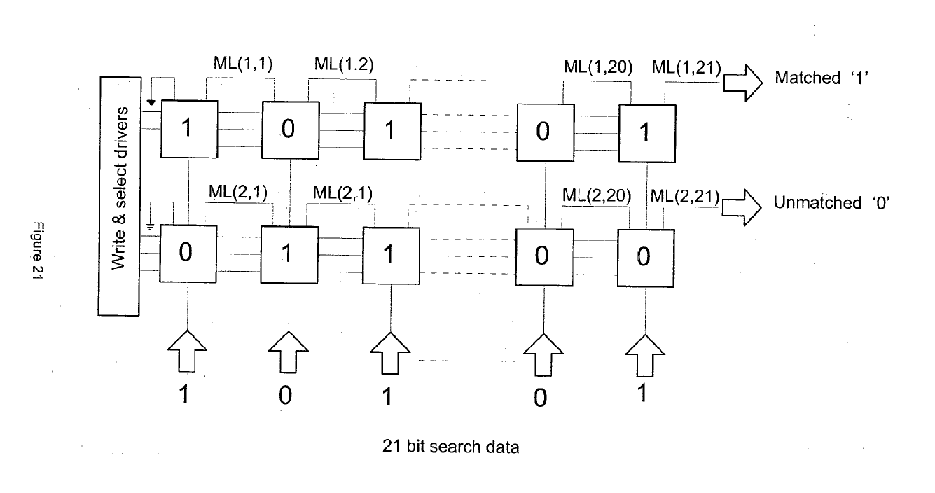

The NAND-type Memristor MOS Content Addressable Memory (MCAM) structure depicted in FIG. 20 operates in a satisfactory manner for small word lengths in terms of the speed of operation in many applications such as image coding and a variety application such as the Hough Transformation, where it can enable the extraction of the shapes by comparing stored data in CAM with data in a search register; the Huffman coding, where a Fixed-length to Variable-length code transformer (similar to Morse code) takes a fixed length input character block and transforms it into a variable length output block; the Lempel-Ziv Compression; where a Variable-length to Fixed-length code transformer can be implemented for a large class of sources; and with respect to Adaptive dictionary-based uses previously seen with text to build a dictionary.

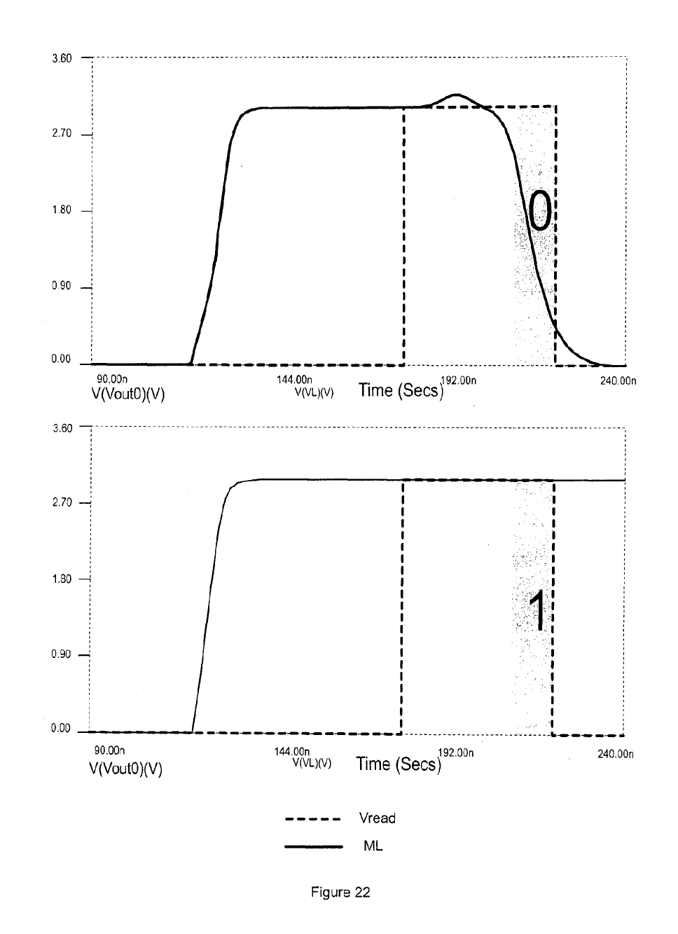

However for long word lengths in applications such as packet forwarding and packet classification in Internet routers as required by search engines, the MCAM cells need to be cascaded as shown in FIG. 21. Delay as illustrated in the waveform in FIG. 22 will reduce the speed of operation. Therefore the NAND based MCAM circuit shown above is suitable for a small word length. When they are cascaded for long word lengths, delay will reduce the speed of the search operation.

A solution to speed up is to divide cells in groups of three and then AND-ing the Match lines using NOR-type based structure as well as a keeper transistor.

In FIG. 21 and FIG. 5 22, in this circuit configuration a “0” represents matched output.

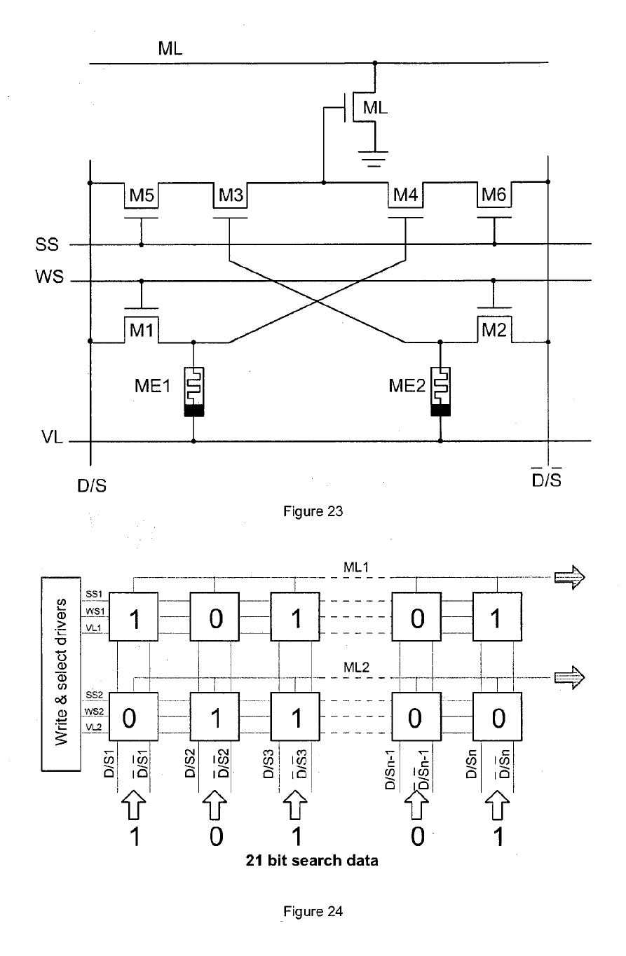

To speed up circuit operation a improved by Cross-connected NOR-type MCAM shown in FIG. 23. The rational to use Cross-connected NOR-type MCAM is to receive “1” when there is a match and “0” when otherwise. A keeper transistor ML enables the MCAM Cell to acts like a NAND-based circuit even thought it is naturally a NOR-type structure as depicted in FIG. 14.

For a Read operation the following sequence applies:

a) VL line is asserted by pulse with amplitude voltage corresponding to Vdd.

b) The Search data is applied on D/S and −D/−S (bar).

c) The operation used here to performing a logical operation corresponds to XOR operation, that is: (Data) AND (Memristor Data bar) OR (Data bar) AND (Memristor Data).

d) At this stage either (Data) and (Memristor Data bar) are matched or (Data bar) & (Memristor Data) are matched, which results in the Match line to be discharged.

e) Thus far the operation is similar to NAND-type MCAM but a NOR-type MCAM is used.

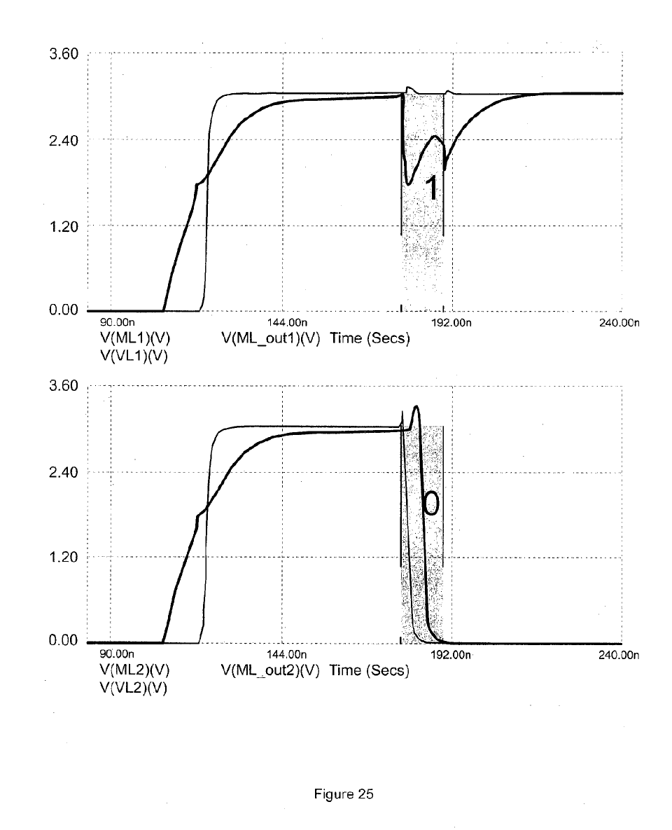

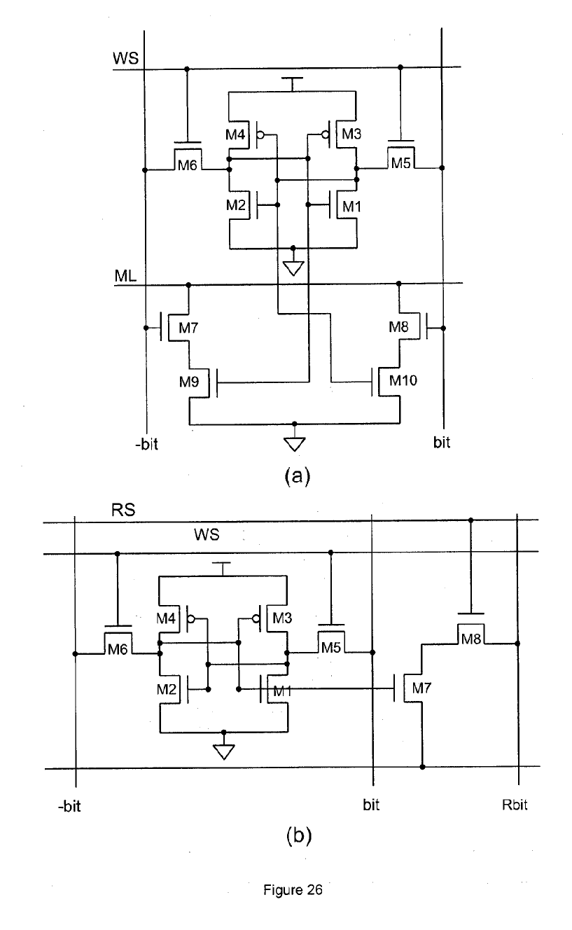

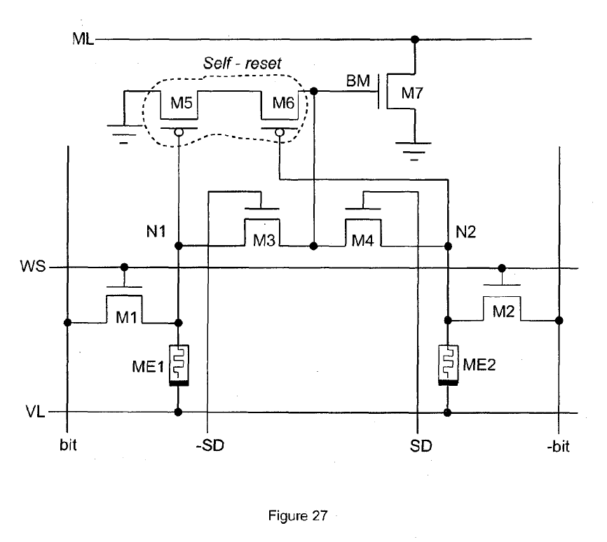

f) A keeper transistor on ML (a minimum size PMOS with zero gate) is always ON to charge the Match line at anytime. Using this technique, this NOR-type structure provides NAND-type result with a small delay. A 21-bit structure can be found and is stimulated as shown in FIG. 24 and FIG. 25 respectively.

In this structure “1” means matched.

This system only provides information about the presence of a given search term within any of the web pages or documents contained in the MCAM array. It is also desirable that the result of a given search term being applied to the MCAM array provide information about the frequency of said search term within the given MCAM block and/or the term's position within said MCAM. This information may be provided in addition to said binary logical result to help rank the pages containing said search terms.

The power saving features of this invention may be further exploited. A short search term such as the word “test” may be applied to a very large MCAM block capable of indexing 32 character words. In this case, only those parts of the MCAM block pertaining to the first four characters of the MCAM need be powered. A search mask may be applied such that only those elements of the search term that are active are powered in the MCAM. This approach can be applied recursively with sub MCAM elements also employing selective powering.

This invention is not limited to the Inverse or Forward indices. They are merely shown here by way of example. The MCAM architecture may be applicable to other search engine indexing schemes as would be readily apparent to those skilled in the art.

In another embodiment, this broad aspect of the invention provides an architecture for data mining applications. With the amount of data doubling at an astonishing rate these days, data mining is becoming an increasingly important tool to transform these massive data sets into meaningful information. One area that has ever increasing data sets is the medical records field. Both the quality and quality of data is improving. Medical imaging for example provides finer resolution all the time. A typical Magnetic Resonance Imaging (MRI) scan these days provides hundreds of slices through the body with the resulting 3-dimensional images allowing surgeons to plan operations with great clarity.

Data mining (of medical data beyond simple imaging data) is providing greater insights into disease formation and progression. It is also allowing healthcare professionals track disease outbreaks and predict possible transmission scenarios. Explanations are being proposed for disease clusters whose patterns would be otherwise undetected through data mining. Global repositories of medical imaging and data are already under consideration and the value of these applications in the betterment of mankind are only at the beginning stages of development.

In another embodiment, this broad aspect of the invention provides an architecture whereby an MCAM is used for image comparison, identification and image matching for security camera applications. Images from image sensors are applied to the MCAM and degree of similarity are tagged.

Security is becoming more important in the modern world. Of particular interest to security organizations is the location or detection of persons of interest. One area where this is particularly important is airport security. This is the front line of detection for security organizations. At present, persons of interest can move relatively freely around the world without detection. All they need is a false passport and they can move freely using commercial airports. Security cameras are ever present in airports; however they are used primarily for monitoring, looking for disturbances and obvious security breaches. A system for capturing biometric data from people moving around the airport (or indeed at security checkpoints) and comparing them to a database of persons of interest would improve public safety and national security.

In a preferred embodiment, an image sensor acquires an image of a person. Computer algorithms for image recognition are used to determine key biometric identifiers of the person (for example, distance between eyes, length of nose, position of the corners of the mouth relative to the chin etc). This results in an array of biometric data. Data may contain absolute measurements of biometric data in the case where a fixed camera is used at a security checkpoint or relative data. The biometric data is fed into the search term bus of a Content Addressable Memory (more specifically a Memristor Content Addressable Memory) and if a match is obtained, details of the person of interest may be retrieved from the memory in minimal time.

Said image recognition algorithms may also mark key biometric points on an overlay of the image. Passing the overlay directly into the CAM would reduce the computational burden and speed up the process.

Biometric data stored within the MCAM may contain only front-on biometric measurements. However it would also be possible using an MCAM structure to store many data sets that correspond to a given individual when viewing said biometric features from a variety of angles.

This data must be quickly compared to a database of known persons of interest and a match determined while the person is still within the local area. Furthermore in areas with a large number of security cameras it would be possible to track a person of interest in real time as they pass successive cameras and be of particular interest in looking for these people among the community.

Another application of this is in fingerprint recognition. Current finger print analysis is based on only a few key pieces of data. The relative location of only a few key fingerprint structures is all that is used to match fingerprints. An MCAM would be able to contain a map of the entire finger print (2-dimensional array). This would improve fingerprint recognition and the MCAM structure would allow detection of the correct fingerprint in a single clock cycle once it has been pipelined or shifted into the MCAM.

Another application of this invention relates to image recognition for targeting. This is particularly important for the military.

In yet another embodiment of the present invention a memristor content addressable memory would aid in the image extraction process. An image acquired from a conventional CCD camera needs intensive software processing in order to extract the key biometric data in the first place. An MCAM can be loaded with a biometric mask. The image from a camera or sensor is pipelined through the MCAM sooking for a two-dimensional match.

A further application involves Fourier analysis of an image to look for characteristics that correspond to a known target. An image is captured on a camera with a Fast Fourier Transform (FFT) being performed on the two dimensional data array. An FFT provides of a two dimensional image represents the frequency components that make up the image in both dimensions. Once an FFT has been performed, the resulting spectral information can be passed through a CAM looking for a match between the spectral content of the image and the spectral content of the target, which has been stored in the content addressable memory.

A further extension of this involves optical techniques. An image can be focused onto a camera, which provides an intensity map of the field of view. However when you focus an image down, the focal plane of the lens is a Fourier transform of the input image. It is then possible to place a camera at the focal plane of a lens or mirror and directly image the Fourier components for the field of view. This is then analysed with an MCAM in a single clock cycle process.

In yet another embodiment, the present invention provides a method and apparatus for providing ultra fast compression in low power applications. In a preferred embodiment the CAM implements a learning compression algorithm, for example the Lempel-Ziv-Welch algorithm. The CAM is initialized by writing single character strings that correspond to all the possible input characters (plus clear and stop codes if they're being used) into the CAM.

The data or file to be compressed is passed into the CAM in such a way that the next character is appended to the compare register. At each step, the compare register is latched into the search bus of the cam. The algorithm works by scanning through the input file for successively longer substrings until it finds one that is not in the CAM. At each step, when a string is found in the CAM, the index of that string is latched into a 2-bit shift register such that the data in bit 0 of the register is shifted to bit 1 of the register on clocking. When a search term string is not found in the CAM, it is written to the next available location in the CAM and the content of bit 1 of the shift register is written to the next available memory location in the decoded memory space. The last input character is then used as the next starting point to scan for substrings.

In this way, successively longer strings are registered in the CAM and made available for subsequent encoding as single output values. The algorithm works best on data with repeated patterns, so the initial parts of a message will see little compression. As the message grows, however, the compression ratio tends asymptotically to the maximum.

After the entire file has been compressed, there are two arrays. The contents of each occupied CAM row and the encoded memory. The CAM contents provide the data and the memory provides the index to the data.

The decoding algorithm works by reading a value from the encoded memory array and outputting the corresponding string from the array of CAM data, otherwise known as the dictionary. At the same time it obtains the next value from the input, and adds to the dictionary the concatenation of the string just output and the first character of the string obtained by decoding the next input value. The decoder then proceeds to the next input value (which was already read in as the “next value” in the previous pass) and repeats the process until there is no more input, at which point the final input value is decoded without any more additions to the CAM.

In this way the decoder builds up a CAM which is identical to that used by the encoder, and uses it to decode subsequent input values. Thus the full CAM contents do not need be sent with the encoded data; just the initial single-character strings is sufficient. This is typically defined beforehand within the encoder and decoder pairs rather than being explicitly sent with the encoded data.

Furthermore a memristor content addressable memory allows low power consumption as only those elements of the memristor content addressable memory that are required for encoding or decoding are powered at any one time. It would also be appreciated by those skilled in the art that other compression algorithms would be suitable for compression with a memristor content addressable memory. Selection of the algorithm is dictated primarily by the type of data to be compressed.

The CAM can provide single clock cycle lookup and data compression (and extraction) with elements of the memristor content addressable memory being selectively powered to save battery life in mobile applications. If the data can be sent in packets and sufficient data can be compressed in a short period of time to make the compression algorithm efficient, then this method could be applied to mobile phones and other personal communication devices to minimize both the compression power consumption (through selective powering of memristor content addressable memory elements) and the power consumed in physical transmission of the signal.

Another application is in satellite communication and deep space exploration. Increasing data bandwidth is a growing problem for communication satellites. As bandwidth consumption increases globally, the satellite must deliver greater data payloads while having limited on-board battery backup and a solar power source that degrades over time. The situation is even worse for deep space exploration, where more and more of the dwindling power budget must be diverted to high gain communication transmissions back to Earth.

The MCAM based cipher of the present invention can help solve both of these problems.

A further embodiment of the invention is Memristor Ternary Content Addressable Memory (MTCAM) which employs the Ternary Content Addressable Memory (TCAM) architecture; an application specific memory having three states: binary states “0” and “1” and a don't care state “X”.

In the Memristor Ternary Content Addressable Memory masking of data can be carried out both globally (as in the search key) or alternatively locally (as in the form of table entries) in order to achieve nearest match in environments where perfect match is not needed. The Memristor Ternary Content Addressable Memory of the present invention is particularly useful in some classes of image recognition where an exact match between the template vector and search data is not necessary. In these circumstances the state “X” can be used as a mask for partial matching of data. The partial match feature makes it attractive for applications such as image recognition. Memristor Ternary Content Addressable Memory (MTCAM) with self-rest cell transistors M5 and M6 and memristors ME1 and ME2 that can store“01”, “10” and “00” is shown in FIG. 27.

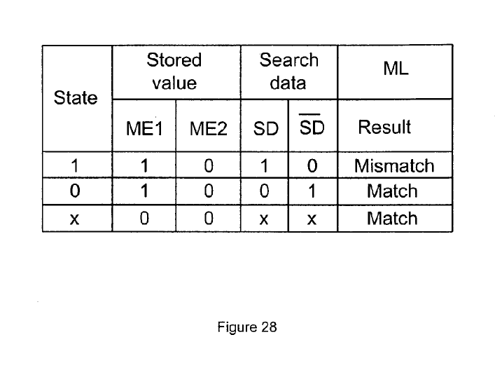

An encoding table for the Memristor Ternary Content Addressable Memory (MTCAM) cell is shown in FIG. 28.

Each memristor ternary content addressable memory element or cell consists of two memristors ME1 and ME2 that can store “01”, “10” and “00”. “00” state corresponds to “X”, while “11” is a “not allowed” state. M5 and M6 are self-resetting transistors and ensure that the gate of match line transistor M7 remains at “0”. When standby in the match operation VL is set “0” and transistors M5 and M6 turn “ON” and reset bit match node BM.

This node masks all cells, thus eliminating the occurrence of floating N1 nodes. Match operation is completed in three steps.

(a) the match line (ML) is pre-charged

(b) search data (SD, −SD) are activated

(c) VL is enabled and stored data (ME1, ME2) is transferred to the BM node.

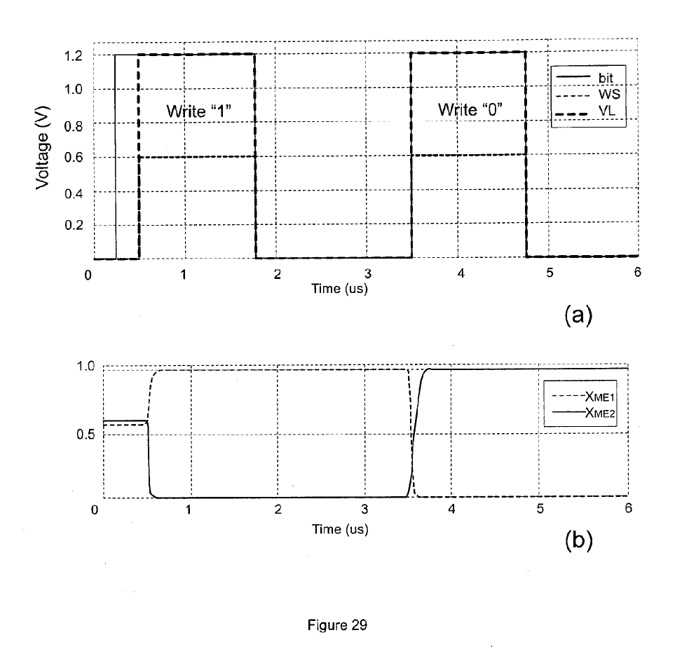

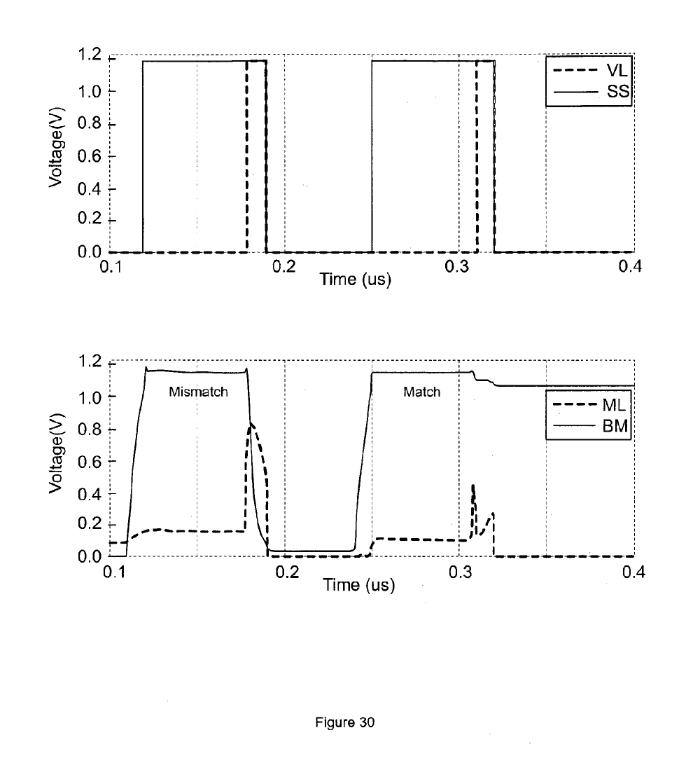

The VL pulse width for read operation is 12 ns using current technology. This is the “minimum” pulse width required to retain Memristor state. The related Write operation waveforms together with that of Match timing are shown in FIG. 29 and FIG. 30 respectively.

The time for a state change is approximately 75 ns for ME1 and 220 ns for ME2. Therefore, a 145 ns delay is imposed because of the voltage drop across the ME2. In a match case, pre-charged ML remains high state. In a mismatch case, one of the pull down paths enables and discharges the match line (ML) to GND, through transistor M7.

Using this architecture, an MCAM element may be masked from the search term by setting both memristors (of a content addressable memory element that stores its data and the complement of said data into a pair of memristors as shown in FIG. 27) to a ‘low’ state.

Appropriately designed MCAM structures can provide significant benefits to this field. It will be readily appreciated by those skilled in the art that the present invention is applicable to any number of different data mining applications, in medicine, business, science and beyond.

This invention provides a new approach towards the design of Memristor Content Addressable Memory (MCAM) based on a Memristor-MOS-Memory architecture, using a combination of memristor MOS devices to form the core of a memory/compare logic cell that forms the building block of the CAM architecture. The combination of Memristor-MOS Logic retains data when the power source is removed without the need for the power consuming refresh techniques and provides for reduction of circuit area which further increases the packing density of basic Memristor Content Addressable Memory (MCAM) cell with significant power reduction that consequently would allow building of larger Content Addressable Memory (CAM) arrays.

It will be readily appreciated by those skilled in the art that the various embodiments presented in this disclosure can be combined as desired and are in fact intended to be combined to provide additional functionality in preferred embodiments. The embodiments presented herein are not intended to present a limitation on the scope of the present invention, rather they serve to highlight certain aspects of the much broader present invention.

1. (canceled)

2. A non-volatile Content Addressable Memory element including:
a non volatile memristor memory element;
a data bus for applying a data signal to be programmed into said memristor memory element;
a search bus for applying a search term;
an output or match bus;
logic to selectively enable said search bus and said data bus;
wherein said logic is configurable to set the logic state of said memristor according to a logic signal applied to said data bus, and configurable to enable the logic state of said memristor to be compared to a logic state on said search bus with said match bus signaling a true logic state upon matching.

3. A non-volatile Content Addressable Memory element including:
a plurality of non volatile memristor memory element;
a plurality of data buses;
a plurality of search buses;
a plurality of data buses;
an output or match buses;
logic to selectively enable said plurality of search buses and said plurality of data buses;
wherein said logic is configurable to set the logic state of a first memristor according to a logic signal applied to a first data bus, the logic state of a second memristor according to a logic signal applied to a second complementary data bus, and configurable to enable the logic state of the first memristor to be compared to a logic state on a first search bus, to enable the logic state of the second memristor to be compared to a logic state on a second complementary search bus, and said match bus signaling a true logic state upon matching.

4. A non-volatile Content Addressable Memory including:
a plurality of non-volatile content addressable memory elements as claimed in claim 2 arranged in a two dimensional array;
a search register for storing a search term;
a plurality of search buses for providing the bitwise contents of said search register to a plurality of one-dimensional lines of said non-volatile content addressable memory elements;
a plurality of match busses, each match bus providing a plurality of match signals, one of said match busses for each orthogonal one-dimensional line of said non-volatile content addressable memory elements;
a match bus comparator for each of said plurality of match buses for providing a logic true state when all of said plurality of match signals within a given one of said match busses is a logical true;
an encoder output register for latching the contents of said match buses;
wherein data is latched into said search register for bitwise comparison to the contents of said plurality of content addressable memory elements and wherein said encoder output register contains the address in memory of the where said data matches the contents of said content addressable memory.

5. A non-volatile Content Addressable Memory as claimed in claim 4 wherein said plurality of search buses for each of said memory elements and said plurality of their respective data buses are combined into a plurality of single search write buses and further including logic to selectively control search and data write functions.

6. A high speed non-volatile content addressable memory as claimed in claim 4, wherein supply of power for each of said content addressable memory elements is individually configurable.

7. A high speed non-volatile content addressable memory as claimed in claim 4, wherein groups of content addressable memory elements are powered as a block.

8. A high speed non-volatile content addressable memory as claimed in claim 7 wherein the state of each of said memristor element is retained during power down and not requiring data to be loaded back into the memory when said high speed non-volatile content addressable memory is powered up again.

9-18. (canceled)

19. A method of providing a search engine, including:
configuring a plurality of memristor content addressable memories blocks to each store a different one of a plurality of data records;
sequentially latching a plurality of search terms into the Search Data Register of each of said memristor content addressable memory blocks;
sequentially latching the output of each of said plurality of memristor content addressable memories into a shift register;
wherein each bit of said shift register contains a logical true or false corresponding to the presence or otherwise of said search term within each of said respective memristor content addressable memories blocks.

20. A method as claimed in claim 19 wherein said content addressable memory is comprised of memristor content addressable memory elements.

21. A method as claimed in claim 19, wherein shift register includes an Inverse Index of said plurality of search terms in said plurality of data records.

22. A method as claimed in claim 19, wherein said data record corresponds to a single document or web page.

23. A method as claimed in claim 19, further including rapidly reconfigurable power management;
wherein power is only applied to the memristor content addressable memory blocks that are to be searched, and where memory does not need to be refreshed upon power-up.

24. A method as claimed in claim 23, further including a search term mask for reducing power consumption including:
a means of determining the length of a given one of said search terms;
generating a mask corresponding to the number of bits in said search term;
applying said mask to the power grid of said memristor content addressable memory block;
controlling the power grid of said memristor content addressable memory block in rows;
wherein only those rows of said memristor content addressable memory block which are required to search said search term as defined by said mask are in a powered-up state.

25. A method as claimed in claim 19 wherein memristor content addressable memory blocks are cascaded for improved data management, speed or memory usage.

26. An apparatus for providing a search engine, including:
a plurality of memristor content addressable memory elements as claimed in claim 2, arranged in a two dimensional grid arrangement;
a search register for storing a search term;
a plurality of search buses for providing the bitwise contents of said search register to a plurality of one-dimensional lines of said non-volatile content addressable memory elements;
a plurality of match busses, each match bus providing a plurality of match signals, one of said match busses for each orthogonal one-dimensional line of said non-volatile content addressable memory elements;
a match bus comparator for each of said plurality of match buses for providing a logic true state when all of said plurality of match signals within a given one of said match busses is a logical true;
an encoder output register for latching the contents of said match buses;
wherein data is latched into said search register for bitwise comparison to the contents of said plurality of content addressable memory elements and wherein said encoder output register contains the address in memory of the where said data matches the contents of said content addressable memory.

27. An apparatus as claimed in claim 26, wherein memristor content addressable memory elements and combined in blocks with each block sharing a common power source and said blocks are powered selectively.

28. An apparatus as claimed in claim 27, further including a search term mask for reducing power consumption including:
a bit mask for determining the length of a given search term;
a power controller for selectively configuring the power within each of said memristor content addressable memory blocks;
wherein only those rows of said memristor content addressable memory block which are required to search a given search term as defined by said mask are in a powered-up state.

29. An apparatus as claimed in claim 26 further including a means for cascading the output of memristor content addressable memory blocks providing improved data management, speed or memory usage.

30-76. (canceled)
